(19) United States
(12) Patent Application Publication
(10) Pub. No.: US 2025/0347775 A1
(43) Pub. Date: Nov. 13, 2025

(54) DETECTION AND CLASSIFICATION OF UAVs

(71) Applicant: SAAB AB, Linköping (SE)

(72) Inventors: Stefan ERIKSSON, Landvetter (SE); Michael ANDERSSON, Varberg (SE)

(21) Appl. No.: 18/870,534

(22) PCT Filed: Jun. 2, 2023
(86) PCT No.: PCT/SE2023/050547

§ 371 Date: Nov. 29, 2024

(30) Foreign Application Priority Data
Jun. 2, 2022 (SE) 2200059-0

(51) Int. Cl. G01S 7/41; G01S 7/288; G01S 13/88

(52) U.S. Cl. CPC G01S 7/412; G01S 13/88; G01S 7/2883

(57) ABSTRACT

The present disclosure relates to a method for detection and classification of aerial objects, the method including obtaining, in an input detection unit, a radar input signal from a radar station. Further including processing, in a processing unit, a pre-configured sample data window of the detected input signal by using a spectral analysis method to obtain spectral data and extracting fundamental tones from said spectral data by using an estimation technique. Moreover, the method measures, in the processing unit, statistical features between the extracted fundamental tones and detects and classifies objects by comparing, in the processing unit, the measured statistical features with at least one pre-defined reference feature.

### TECHNICAL FIELD

The present invention relates to detection and classification of objects with detectable moving or rotating parts, and more specifically to analysing statistics of detected tones of radar signals to identify features and in order to categorize and discriminate objects.

### BACKGROUND

Unmanned aerial vehicles (UAV) or drones have gained increased interest from the commercial market. These are aerial vehicles without a human pilot on-board. Such aerial devices can be remotely controlled from ground either by a human operator or autonomously by a processing device on-board the vehicle. They have also been a main component of unmanned aircraft system (UAS) for missions without a human pilot on board. While they initially originated mostly for surveillance applications, they have now rapidly gained interest in commercial, agriculture and cargo drones.

The use of unmanned aerial vehicle has several advantages, for instance, they are considered more reliable and economical and it is possible to reduce risks for operators of the vehicles. However, with the increasing use of such unmanned aerial vehicles there is also an increased threat to the privacy and security of individuals, business or even countries.

Thus, there exists a need to regulate the usage of unmanned aerial vehicle by applying rules such as privacy regulations, security regulations, certificate requirement and more depending on the usage in commercial or private domain. There are certain set of regulations proposed by different national and international organizations to control the effect of unmanned aerial vehicles on people's safety, security and privacy.

Considering the above security and privacy issues, some preventive measures are taken by various organisations, for instance detection and discrimination methods are proposed to identify an unmanned aerial vehicle that may breach the privacy of an organization or location. With the increasing usage of unmanned aerial vehicle in day-to-day life there remains a great interest to prevent unidentified unmanned aerial vehicle from entering a territory. Thus, there is a need for efficient techniques and methods to identify aerial vehicles and detect intrusions.

### SUMMARY

The present invention is disclosed by the subject-matter of the independent claims. One aspect of the present invention is a method as defined in independent claim 1. Other aspects of the invention are device and system. Further aspects of the invention are the subject of the dependent claims. Any reference throughout this disclosure to an embodiment may point to alternative aspects relating to the invention, which are not necessarily embodiments encompassed by the claims, rather examples and technical descriptions useful for understanding the invention. The scope of the present invention is defined by the claims.

It is an object to obviate at least some of the above disadvantages and provide improved method and system for detection and classification of aerial objects.

The method comprises obtaining, in an input detection unit, a radar input signal from a radar station. Further, processing, in a processing unit, a pre-configured sample data window of the detected input signal by using a spectral analysis method to obtain spectral data. Moreover, the method comprises the step of extracting fundamental tones from said spectral data by using an estimation technique. Moreover, the method comprises measuring, in the processing unit, statistical features between the/of the extracted fundamental tones and detecting and classifying objects by comparing, in the processing unit, the measured statistical features with at least one pre-defined reference feature. The method may be a computer implemented method.

An advantage of the method in accordance with the present disclosure is that it provides increased accuracy compared to conventional methods.

Moreover, the method provides shorter illumination times, lower false alarm and faster volume scan times compared to conventional solutions.

The step of obtaining the radar input signal may comprises sampling the radar input signal at regular intervals.

An advantage of this is that the certainty of the estimation is increased based on the increased number of samples.

The pre-defined reference feature may be a reference set of statistical features from known aerial objects.

An advantage of this is that the extracted fundamental tones can be compared to the reference set so to determine an object as detected/classified.

The spectral analysis method is one of digital Fourier transform, DFT, Fast Fourier transform, FFT, or a high resolution spectrum estimation method.

Further, the estimation technique to extract fundamental tones is an Estimation of Signal Parameters via Rotational Invariance Technique, ESPRIT. ESPRIT provides a reliable and convenient set of fundamental tones that consequently can be further processed in a fast manner.

The statistical features may comprise at least one of mean, median, standard deviation (SD), or variance. E.g. a variance/median/mean/SD between a predefined number of tones in said sample window. Accordingly, the extracted fundamental tones may be subject to calculation of at least one of the above features which can then be, alone or jointly, compared to the reference set of features so to derive the object classification.

The object may be an unmanned aerial vehicle, UAV.

The statistical features may be indicative of at least one physical trait of an aerial object or physical trait of a component of an aerial object, the physical trait being at least one of velocity, material and dimension. Further, the components may be at least one of rotor blade, a skid, a tail, a fin, a wing or a fastening means.

Thus, the method allows for detection and classification of a higher quantity of aerial objects of different types/sizes/models.

The step of detecting and classifying objects may comprise categorizing the objects into different types/models of unmanned aerial vehicle, UAVs, or other objects. In some aspects, the classifying may also comprise categorizing the objects into different size-categories of UAVs.

The detecting and classifying may be performed by comparing, in the processing unit, the measured statistical features with a plurality of pre-defined reference features and matching said measured statistical features to one of said pre-defined reference features being most correlative relative said measured statistical features. Thus, the statistical features may be a plurality of statistical features.

An advantage of this is that the method may detect/classify objects that in other methods may be mistaken for one another by comparing to a plurality of reference features. Thus, the classification capability of the method herein is increased.

Further, when detecting and classifying the method may determine a likelihood of a hypothesis, the hypothesis being whether a detected aerial object belongs to a specific classification conditional on said statistical features. The hypothesis may be determined by a statistical processor in a radar station. A benefit of this is that a hypothesis may add additional validity to that the matching between statistical features and pre-determined reference features is actually correct.

The disclosure further relates to a system for detection and classification of aerial objects comprising an input detection unit, a processing unit, a memory unit, the system being configured to perform the method according to any aspect herein.

There is also disclosed a computer-readable storage medium storing one or more programs configured to be executed by at least one of an input detection unit and a processing unit of a system, the one or more programs including instructions for performing the method of any aspect herein.

### BRIEF DESCRIPTION OF THE DRAWINGS

In the following, the invention will be described in a non-limiting way and in more detail with reference to exemplary embodiments illustrated in the enclosed drawings, in which:

FIG. 1 is a schematic diagram illustrating a radar system;

FIG. 2 is a schematic block diagram illustrating an exemplary processing unit;

FIG. 3 is a schematic block diagram illustrating an example method; and

FIG. 4 is a schematic F3ₐₘₚ result for an object based on a measuring window.

FIG. 5 depicts extracted fundamental tones from a signal reflected from an aerial object

### DETAILED DESCRIPTION

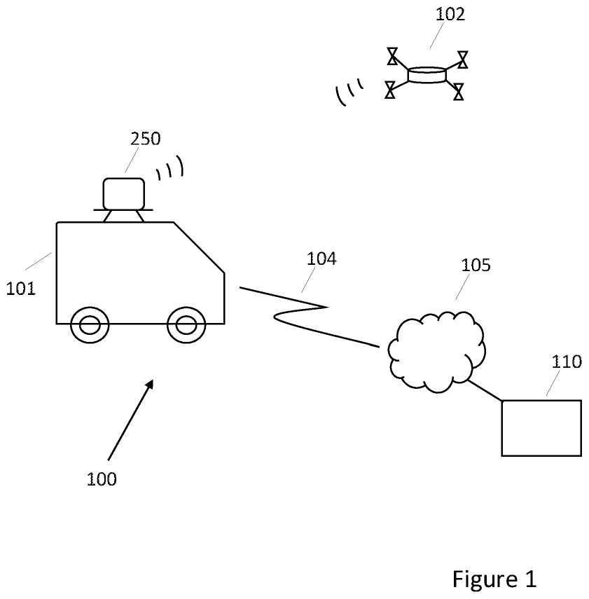

Reference numeral 100 in FIG. 1 generally depict a system for detecting aerial objects 102 with a radar transceiver 250. The radar transceiver 250 may be positioned in a radar station, e.g. a radar unit vehicle 101 or a fixed location, for instance at an airport. This type of radar application may be used in different radar applications such as automotive radar, flight radar, tracking radar, surveillance radar, and so on. It should be noted that the radar transceiver 250 may also be arranged with separate radar transmitter antenna(s) and separate radar receiver antenna(s), i.e. be of mono-, bi-, or multi-static type. The radar station may be connected to a central control station 110 via a communication link 104 via a network 105. The communication link 104 may be wireless or wired depending on type of radar station installation. In one application, the system is arranged to use the radar to detect and identify UAVs (unmanned aerial vehicles), unmanned aircraft systems (UAS), or drones; for example small drones with several rotors.

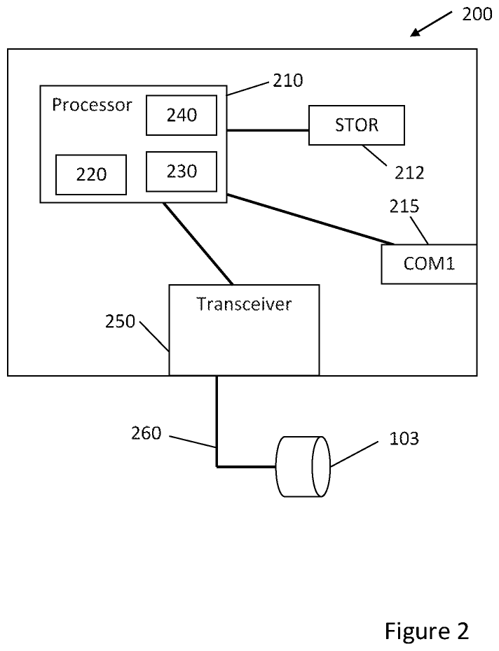

FIG. 2 show a control unit 200 comprising at least one processing unit 210, at least one memory unit 212 for storage of data and computer programs for operating functions, at least one communication interface 215, and at least one transceiver 250. The transceiver 250 is connected to an input detection unit 103 e.g. a RADAR signal receiver for detecting radio signals. The input detection unit 103 detects the radio signals from an aerial object e.g. unmanned aerial vehicle, the radio signals has been transmitted from a radar transmitter and detected with a radar receiver. The detected input signals are sampled in the transceiver 250. This sampled signal is further processed in the processing unit 210 as will be discussed later in this document. The processing unit may constitute one or more processors e.g. a pre-processor 220, a post-processor 230 and a statistical processor 240. The processing unit 210 obtains a spectral data by using a spectral analysis method on the received pre-configured sampled data window of the detected input signal. The processing unit 210 further obtain fundamental tones of the spectral data by using an estimation technique to extract signal parameters e.g. fundamental tones forming descriptive statistics for the detected objects. The statistical processor may 240 calculates features from the extracted fundamental tones forming descriptive statistics for detected objects. The processing unit 210 is further connected to the storage device 212, which stores one or more pre-defined statistical reference features. Finally, the processing unit 210 detects and classifies objects by comparing the measured statistical features with at least one pre-defined reference feature.

The processor may be any suitable type, such as, but not limited to, a microprocessor, digital signal processor, ASIC (Application Specific Integrated Circuit), FPGA (Field Programmable Gate Array), or similar processing devices operating instruction sets for operating computer program code. It should be noted that a combination of these processor types may be used in cooperation. The storage medium may be one or more of non-volatile and/or volatile type; for instance RAM, EEPROM, flash disk, hard disk, and so on. Furthermore, the computer readable medium may be of transitory or non-transitory type.

The communication port may be of any suitable type such as, but not limited to, Ethernet, I2C bus, RS232, CAN bus, wireless communication technology such as IEEE 802.11 based or cellular based technologies, or other communication protocols depending on application.

The control unit 200 is arranged to execute one or more software programs comprising instruction sets in the one or more processors for operating the radar station and/or receive data from a radar station and for analysing the data for detecting objects and identifying these objects. The objects can be identified by classification into different types of objects, such as UAVs, birds or other objects.

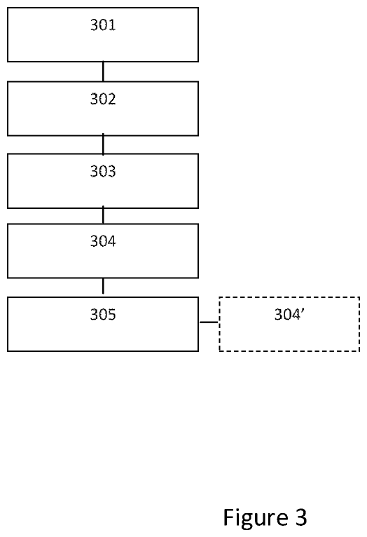

The method of operation will now be described with reference to FIG. 3.

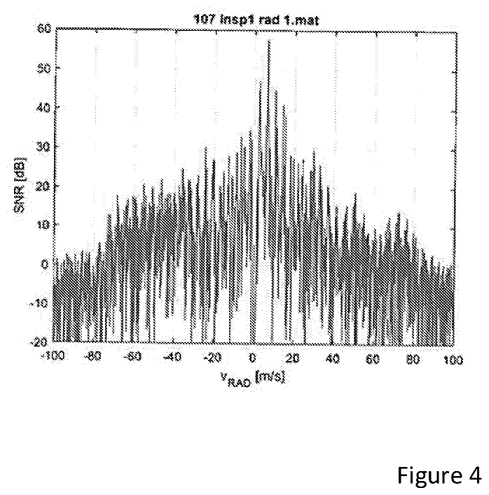

In the first step radar signal data is obtained for instance by obtaining 301, in an input detection unit, a radar input signal from a radar station with data scattered from a target. This radar signal data comprise a pre-set number of data points S(n)-S(n+m), e.g. a moving window of data points, received from the radar station. These data points are sampled data that is processed in the processing unit to identify and classify the type of aerial object from which the input signal was generated. Depending on type of sensor data received, different types of filtering operations, norming of data, or similar data alignments/adjustment may be applied prior to further analysis. Targets, for instance a traditional aircraft, has in general a static body and dynamic propulsive parts, such as one or several propellers, rotors, or turbines. When subjecting such an aircraft to a radar beam, the reflected beam will carry information related to these static and dynamically changing parts, i.e. a dynamic frequency spectrum will be possible to detect in the radar receiver, as seen for instance in FIG. 4. Such a frequency spectrum will look very different depending on how the target is placed in the radar beam, how it is moving relative the radar station, and what type/model/make of the target.

In a second step, the obtained data is processed 302. A pre-configured sample data window of the detected input signal is processed by using a spectral analysis method to obtain spectral data. The spectral analysis method may for instance be suitable Fourier transform algorithm, such as Digital Fourier transform (DFT), Fast Fourier Transform (FFT), or any other suitable spectral frequency transform algorithm. The analysis may provide a spectrogram over obtained radar reflections, i.e. a representation of the spectrum of frequencies and will be an over time dynamically varying signal, which need further analysis to extract useful information. In order to increase the resolution of such data different processing algorithms may be used but with different processing power requirements.

In order to extract suitable data, in the third step 303, fundamental tones are extracted by using an estimation technique to extract signal parameters to obtain tones of the spectra. One such estimation technique is based on Estimation of Signal Parameters via Rotational Invariance Technique (ESPRIT), which determine suitable parameters from a mixture of sinusoids in background noise. An advantage of using ESPRIT is that it provides tones being more convenient to extract data and do further analysis on (i.e. derive statistical features from). Using the ESPRIT analysis, it is possible to efficiently extract and estimate spectral peaks/fundamental tones. ESPRIT gives a direct frequency estimation instead of a spectrogram further facilitating the analysis to detect and identify objects. It should be noted that other spectral analysis technique may be used, preferably, such spectral analysis technique is adapted for deriving spectral peaks/fundamental tones. In other words, the spectral analysis technique may be a spectral peak/fundamental tones estimating technique not limited to ESPRIT.

By listing the estimated frequency of a suitable (plurality of) number of the strongest frequency peaks or fundamental spectral tones the spectral characteristics of the received signal is extracted to be further processed.

In the another step 304, statistical features between the/of the extracted tones of the spectra, e.g. mean, median, standard deviation, variance or any other suitable statistical feature, are measured. These extracted statistical features are unique to a set of aerial objects e.g. quadcopter, bio copter, single-rotor or multi-rotor drones. Further types of targets may be detected and identified such as other UAV types of different make/models, birds, helicopters, windmills, and fans.

In the fifth step 305, detecting and classifying objects by comparing, in the processing unit 210, the measured statistical features with at least one pre-defined statistical reference feature stored in the memory for example in a look-up table in the memory. Based on the closest matched statistical features the classification unit may classify the detected object in one of the object class/categories. In some aspects herein, the detecting and classifying 305 is performed by comparing, in the processing unit 210, the measured statistical features with a plurality of pre-defined reference features and matching said measured statistical features to one of said pre-defined reference features being most correlative relative to said measured statistical features.

Thus, the statistical features may be indicative of at least one physical trait of an aerial object 102 or physical trait of a component of an aerial object 102 the physical trait may be at least one of velocity, material and dimension. Further, the components being at least one of rotor blade, a skid, a tail, a fin, a wing or a fastening means.

From the detection and classification results, it is possible to identify the type of object, and for a UAV even a make/model of the object.

Different setups for the radar application may be used depending on type of objects to be detected and identified. In one embodiment for UAVs, a pulse repetition frequency (PRF) of 7300 Hz or 3650 Hz may be used. Furthermore, depending on the application of the system, a fixed antenna (step-scan) or a rotating antenna may be used. In case of a fixed antenna, the radar may be scanned electronically and in the case of the rotating antenna the antenna is scanned mechanically into different directions to scan regions of interest.

Moving target indication (MTI) filters may be used to distinguish moving targets from clutter and focus measurement and analysis on moving targets or targets with moving or rotating parts. These types of filters can for instance utilize Doppler shifts in the received signals for detecting moving targets.

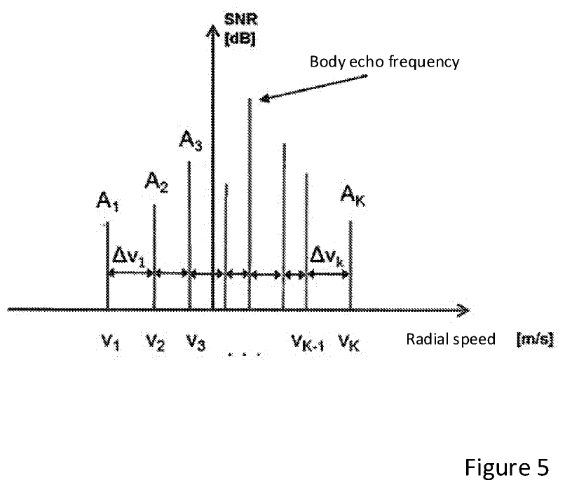

To describe a signals spectral content may be done in several different ways, for instance to determine frequency and amplitude for a number of the strongest spectral components in the obtained signal. In FIG. 5, an example of such data is shown. A number of smaller peaks around a large peak representing the body of the object can be seen, these smaller peaks may be representing radial speeds, e.g. from rotating rotors. The tone denoted “body echo frequency” in FIG. 5 may for instance represent the radial speed of the detected object. Further, the variance may be indicative of for instance blade speed. Further, the sum of the tones may represent any other physical trait, e.g. rotor length or rotor speed. The mean power of the tones may represent another physical trait etc. The method may determine statistical features between individual tones of said tones. Thus, FIG. 5 illustrates that the method may in the step of extracting 303, derive a frequency and amplitude of a plurality of fundamental tones in said spectral data, said fundamental tones being peak tones within said sample data window. By determining the difference in radial speeds between the different peaks, a spectrum descriptor can be determined:

$$Δ {v}_{k} = {v}_{k + 1} - {v}_{k}$$

Extracted fundamendal tones provides an á priori assumed number of complex spectral components:

$${S}_{k} = {A}_{k} \cdot exp ( j \cdot {ω}_{k} )$$

Based on this radial speeds on the tones from the phase is determined:

$${v}_{k} = \frac{{F}_{s} \cdot arg ( {S}_{k} ) \cdot λ}{4 \cdot π}$$

A feature measure F3ₚₕₐₛₑ is given by the median value of tone distance:

$$F {3}_{phase} = median ( Δ {v}_{k} )$$

Furthermore, the amplitude is calculated F3ₐₘₚ to be used so the classification converges faster under the right circumstances. This is calculated as the linear median value on the side tones amplitudes relative body echo in dBc:

$$F {3}_{amp} = 20 \cdot {log}_{10} ( median ( {SNR}_{sidetones} / {SNR}_{bodyecho} ) )$$

If a detection has occurred, the entire data set is used for calculating feature measures and thereafter an a posteriori likelihood for the different hypothesis can for instance be calculated using Bayes theorem, or other statistically based or other value mapping based functions:

$$P ( {H}_{i} \vert F {3}_{phase} , F {3}_{amp} ) ∝ P ( {H}_{i} ) \cdot P ( F {3}_{phase} \vert {H}_{i} ) \cdot P ( F {3}_{amp} \vert {H}_{i} )$$

Thus, after measuring 304, in the processing unit 210 (or statistical processor 240 more specifically), statistical features between the extracted fundamental tones, the method 300 may comprise a step of determining 304′ a likelihood of a hypothesis by e.g. using a value mapping based function. A hypothesis may be, a detected UAV belonging to a specific UAV classification conditional on said statistical features of said extracted fundamental tones. Moreover, if the likelihood of a hypothesis is above a specific threshold the method may classify an object in accordance with the specific UAV classification. The probability of selecting the true hypothesis may be affected e.g. signal to noise ratio of one of said fundamental tones, for example the signal to noise ratio of a body echo. Thus, the step of detecting and classifying 305 may be performed sequentially. Thus, the method 300 may first determine an object as detected. Additionally the method 300 may then, if an object is determined as detected, classify the detected object by comparing, in the processing unit 210, the measured statistical features with at least one pre-defined reference feature. During the classifying, the method may determine 304′ a likelihood of a hypothesis, the hypothesis being whether a detected aerial object belongs to a specific classification conditional on said statistical features and/or pre-defined reference features. Accordingly, if a likelihood of said hypothesis is above a threshold the object may be classified in accordance with method step 305. The specific classification may be the classification being best matching to one of the at least one pre-defined reference feature when compared to the same.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be at least in part implemented by means of both hardware and software, and that several “means” or “units” may be represented by the same item of hardware.

The above mentioned and described embodiments are only given as examples and should not be limiting to the present invention. Other solutions, uses, objectives, and functions within the scope of the invention as claimed in the below described patent embodiments should be apparent for the person skilled in the art. The scope of the present invention is defined by the claims.

1. A method for detection and classification of aerial objects, the method comprising:
obtaining, in an input detection unit, a radar input signal from a radar station;
processing, in a processing unit, a pre-configured sample data window of the detected radar input signal by using a spectral analysis method to obtain spectral data;
extracting fundamental tones from said spectral data by using an estimation technique;
measuring, in the processing unit, statistical features between the extracted fundamental tones; and
detecting and classifying objects by comparing, in the processing unit, the measured statistical features with at least one pre-defined reference feature.

2. The method according to claim 1, wherein the step of obtaining the radar input signal comprises sampling the radar input signal at regular intervals.

3. The method according to claim 1, wherein the pre-defined reference feature is a reference set of statistical features from known aerial objects.

4. The method according to claim 1, wherein the spectral analysis method is one of digital Fourier transform (DFT) Fast Fourier transform (FFT) or a high resolution spectrum estimation method.

5. The method according to claim 1, wherein the estimation technique to extract fundamental tones is an Estimation of Signal Parameters via Rotational Invariance Technique (ESPRIT).

6. The method according to claim 1, wherein the statistical features comprises at least one of mean, median, standard deviation, or variance.

7. The method according to claim 1, wherein the object is an unmanned aerial vehicle (UAV).

8. The method according to claim 1, wherein the statistical features are indicative of at least one physical trait of an aerial object or physical trait of a component of an aerial object;
the physical trait is at least one of velocity, material and dimension;
wherein the component is at least one of rotor blade, a skid, a tail, a fin, a wing or a fastening means.

9. The method according to claim 1, wherein the step of detecting and classifying objects comprise categorizing the objects into different types of unmanned aerial vehicles (UAVs), or other objects.

10. The method according to claim 1, wherein the detecting and classifying is performed by comparing, in the processing unit, the measured statistical features with a plurality of pre-defined reference features and matching said measured statistical features to one of said pre-defined reference features are most correlative relative to said measured statistical features.

11. The method according to claim 1, further comprising the step of, when detecting and classifying:
determining a likelihood of a hypothesis, the hypothesis being whether a detected aerial object belongs to a specific classification conditional on said statistical features.

12. A system for detection and classification of aerial objects comprising:
an input detection unit;
a processing unit; and
a storage device, the system is configured to perform a method according to claim 1.

13. A non-transitory computer-readable storage medium storing one or more programs configured to be executed by at least one of an input detection unit and a processing unit of a system, the one or more programs including instructions for performing the method according to claim 1.
